(19) United States
(12) Patent Application Publication
(10) Pub. No.: US 2010/0086205 A1
(43) Pub. Date: Apr. 8, 2010

(54) NOISE FILTER

(75) Inventor: Seiji YAMAGATA, Kawasaki (JP)

Correspondence Address: ARENT FOX LLP, 1050 CONNECTICUT AVENUE, N.W., SUITE 400, WASHINGTON, DC, 20036, US

(73) Assignee: FUJITSU MICROELECTRONICS LIMITED, Tokyo (JP)

(21) Appl. No.: 12/370,289

(22) Filed: Feb. 12, 2009

(30) Foreign Application Priority Data
Feb. 15, 2008 (JP) 2008-35357

(51) Int. Cl. G06K 9/40; G06K 9/42

(52) U.S. Cl. 382/167; 382/256; 382/260

(57) ABSTRACT

A noise removal circuit in an image signal includes a boundary determination unit configured to determine a position of a light-dark boundary on the basis of, or as a function of, a pixel value of a plurality of surrounding pixels, and a selection filter configured to perform filtering in a range of the plurality of surrounding pixels which belong to a range which does not cross a boundary determined by the boundary determination unit.

### CROSS-REFERENCE TO RELATED APPLICATIONS

This application is based upon and claims the benefit of priority of the prior Japanese Patent Application No. 2008-35357 filed on Feb. 15, 2008, the entire contents of which are incorporated herein by reference.

### FIELD

The embodiments discussed herein are directed to a noise filter for suppressing noise in an image signal.

### BACKGROUND

FIG. 7 is an overall block diagram of a general image sensor system. As depicted in FIG. 7, an external optical input signal 714 is received by each pixel of an image array 701 constituting a CMOS image sensor, for example. A frame pulse for vertical scanning is input from a vertical scanning circuit 702 to the image array 701, and a pulse for horizontal scanning in each line is input from a horizontal scanning circuit 703 to the image array 701.

Each signal obtained by photoelectric conversion and amplification performed for each pixel during every horizontal scanning is taken as an image signal through a column CDS (Correlated Double Sampling) circuit 704. The CDS circuit 704 has a structure wherein a number of pixels equal to the number of columns are arranged in parallel. The obtained signals are further processed by a column amplifier circuit 705, a column ADC (analog-digital conversion) circuit 706, and a column counter 707, and are stored in a line memory 708 in which several lines of image signals are accumulated.

A logic circuit 709 performs signal processing on the image signal stored in the line memory 708. A timing generation circuit 710 supplies various timing signals to each section of an image sensor system. A reference voltage generation circuit 711 supplies a reference voltage to the column CDS circuit 704 and a lamp waveform generation circuit 712. The lamp waveform generation circuit 712 supplies a lamp waveform for AD conversion to the column ADC circuit 706.

In a register 713, for example, a threshold value in defect correction and Bayer noise suppression is set by a user, and the register 713 controls various operations of the image sensor system.

FIG. 8 is a firmware configuration diagram of the logic circuit 709 of FIG. 7. A digital clamp part 801 identifies a ground level. A shading correction part 802 corrects distortion of a lens. An RGB gain adjustment part 803 adjusts an intensity balance of image signals of RGB. A defect correction/Bayer noise suppression/color interpolation part 804 applies defect correction and noise suppression to each pixel in an image signal and performs color interpolation reproduction using three primary colors. An auto white balance part 805 automatically adjusts white balance.

An auto gain control/flicker cancel part 806 controls each analog circuit part in FIG. 7 and performs automatic gain adjustment and prevention of a flicker. A color adjustment part 807 adjusts color balance of RGB. An edge emphasis/RGB noise suppression part 808 applies an edge emphasis processing and a suppression processing of RGB noise to an image signal. A gamma correction part 809 applies gamma correction to an image signal. An output format conversion part 810 outputs a digital signal 715 converted into a format suitable for output.

An example of pixel arrangement in the image array 701 which is an image sensor of FIG. 7 is shown in FIG. 9. This arrangement is referred to as Bayer arrangement. The arrangement of pixels of the same color is shown in FIG. 10 (8 surrounding pixels of the same color) and FIG. 11 (24 surrounding pixels of the same color).

FIG. 12 depicts a relationship between the respective brightness ranges in a defect correction processing and a Bayer noise suppression process performed by the defect correction/Bayer noise suppression/color interpolation part 804 of FIG. 8.

The noise suppression in a notice pixel p0 in the Bayer arrangement (FIG. 9) is often performed at the same stage of the defect correction.

For example, in FIG. 10, an average value pa of the notice pixel p0 and the 8 surrounding pixels of the same color (pa=(p1+p2+p3+p4+p5+p6+p7+p8)/8) is compared. When a difference value between p0 and pa is not less than a threshold value th_w (see, FIG. 12), the notice pixel is detected as a white defect. When the difference value is not more than a threshold value th_b (FIG. 12), the notice pixel is detected as a black defect. When the difference value is less than a threshold value th_n1 (FIG. 12), the notice pixel is detected as the Bayer noise.

The threshold values including th_w, th_b, and th_n1 may be set by a user in the register 713 of FIG. 7. Next, the notice pixel p0 detected as the Bayer noise is replaced by the average value pa of the 8 surrounding pixels of the same color.

Several problems are associated with the prior art techniques described above. The problems are illustrated and described in relation to FIG. 13. By way of example, FIG. 13A depicts an image having a boundary portion between brightness levels, and is assumed to be an ideal image.

Here, as a matter of convenience, an image should to be constituted of only pixels of the same color. Images of R, G, and B can be thought the same way.

In reality, noise is superposed on that image due to various factors, as shown in FIG. 13B. FIG. 13C depicts the quantified brightness (code) of the entire image is. A waveform of the brightness (code) as viewed from an X-X′ cross section of FIG. 13B is shown in FIG. 13D.

For example, when th_n1=10, the conditions of noise suppression are as follows:

### Range A

p0=95
pa=(100+100+100+105+100+100+100+100)/8=100.625
↑p0−pa↑=5.625<th_n1
   noise is suppressed
p0=100.625

### Range B

p0=45
pa=(100+50+50+105+50+100+50+50)/8 =69.375
↑p0−pa↑=24.375>th_n1
   noise is not suppressed
p0=45

### Range C

p0=45
pa=(50+50+50+55+50+50+50+50)/8 =50.625
   |p0−pa|=5.625<th_n1
   noise is suppressed
p0=50.625

Noise is suppressed in a portion where the brightness of an image is uniform; however, in such a portion where the difference is originally large, such as a brightness boundary portion, the difference value exceeds the threshold value th_n1, and thus the noise suppression is not applied (the difference value is within a dead band shown in FIG. 12).

Thus, as shown in FIG. 13E, noise remains in the brightness boundary portion in an output image.

When the threshold value th_n1 is rendered large to remove noise in the brightness boundary portion, a suppression processing is applied to the entire image more than necessary, leading to a loss of sharpness of an original image. Thus, the prior art has a problem that noise generated in the brightness boundary portion cannot be effectively suppressed.

### SUMMARY

According to an aspect of the invention, a noise removal circuit in an image signal, includes a boundary determination unit configured to determine a position of a light-dark boundary on the basis of, or as a function of, a pixel value of a plurality of surrounding pixels and a selection filter configured to perform filtering in a range of the plurality of surrounding pixels, which belong to a range which does not cross a boundary determined by the boundary determination unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an operation flow chart of a first embodiment;

FIG. 2 illustrates a functional block diagram of the first embodiment;

FIG. 3 illustrates an operation flow chart of a second embodiment;

FIG. 4 illustrates an operation explanatory view of the second embodiment;

FIG. 5 illustrates another operation explanatory view of the second embodiment;

FIG. 6 illustrates a functional block diagram of the second embodiment;

FIG. 7 illustrates an entire configuration diagram of an image sensor system;

FIG. 8 illustrates a configuration diagram of a logic circuit;

FIG. 9 illustrates an explanatory view of a Bayer pixel arrangement;

FIG. 10 illustrates arrangement of pixels of the same color (8 surrounding pixels of the same color);

FIG. 11 illustrates arrangement of pixels of the same color (24 surrounding pixels of the same color);

FIG. 12 illustrates an explanatory view of a range of defect correction and Bayer noise suppression; and

FIG. 13 illustrates the related art.

### DESCRIPTION OF EMBODIMENT(S)

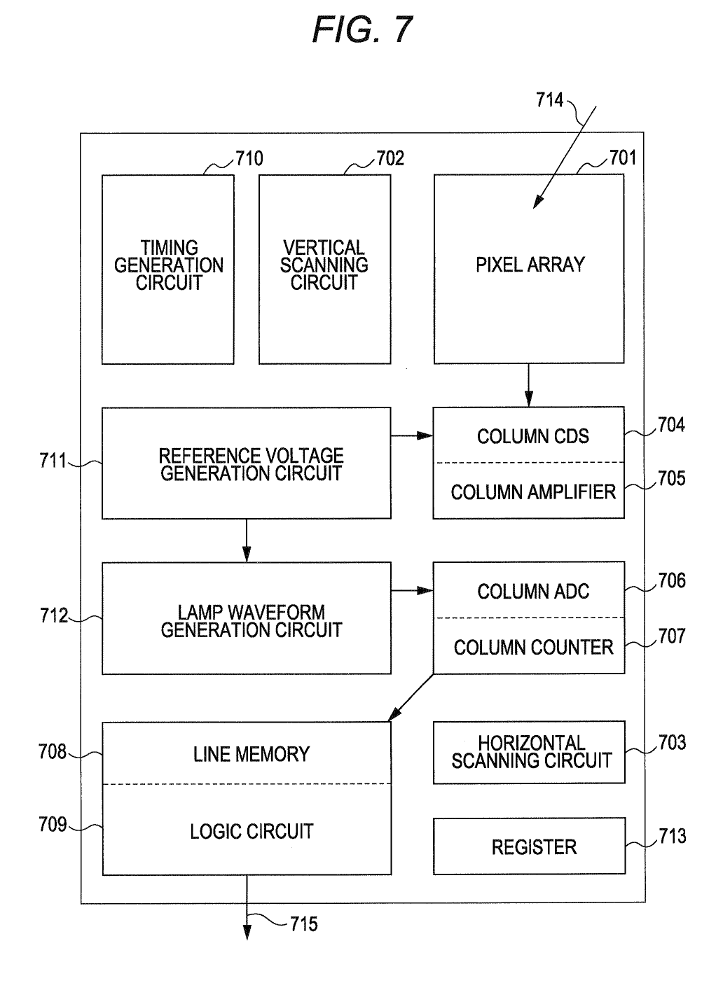

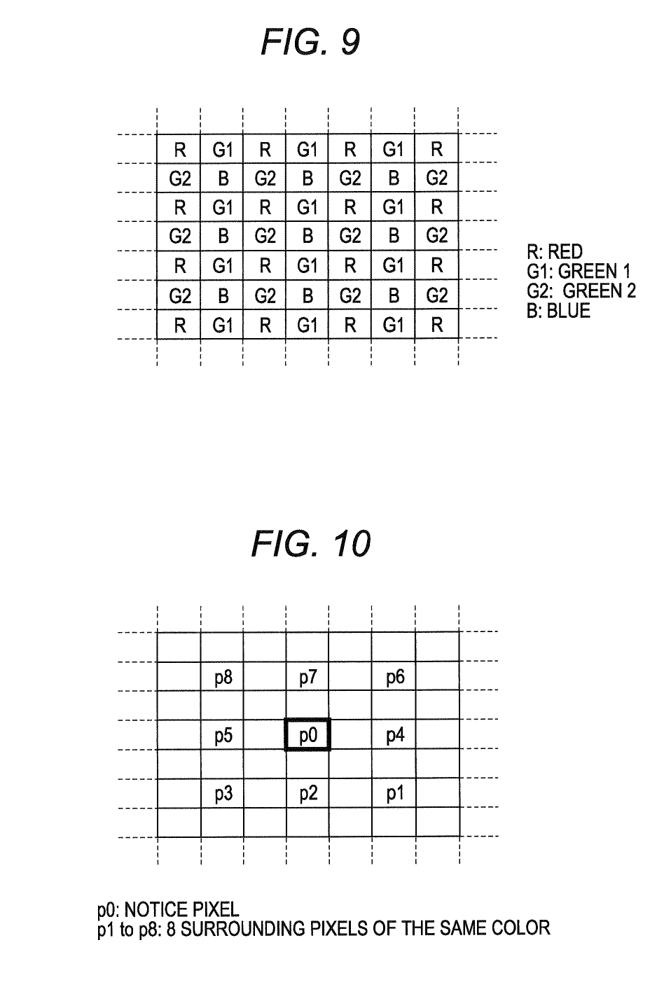

The basic configurations of the first and second embodiments to be hereinafter described are generally the same as the configurations in FIGS. 7 to 12.

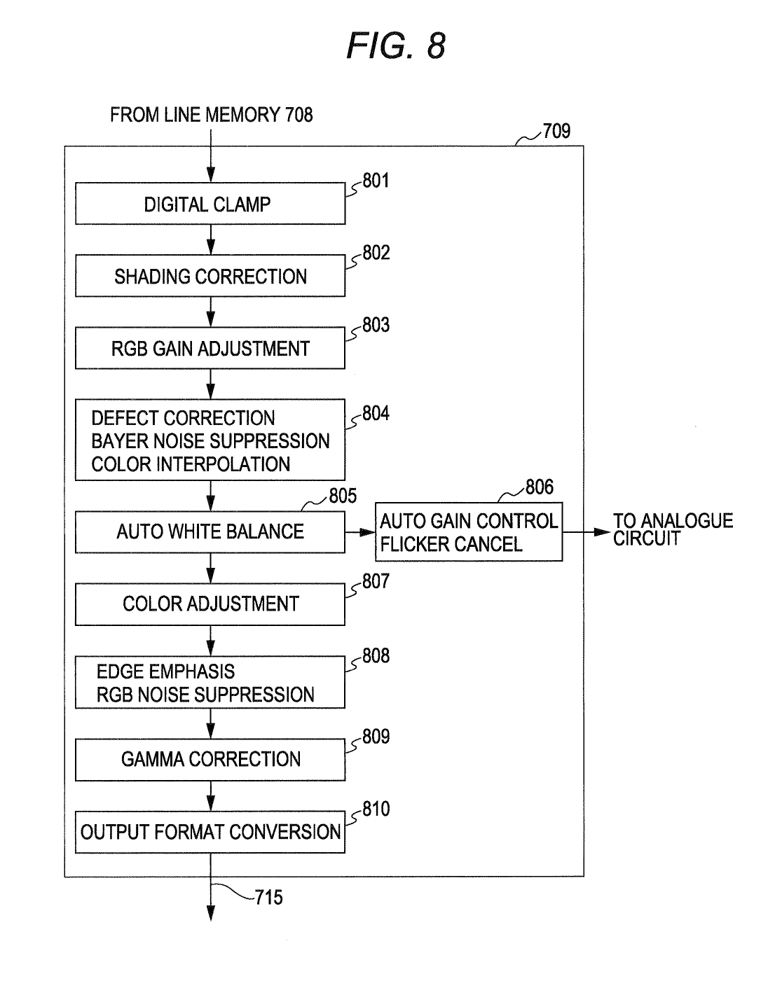

However, the present embodiments are different from the prior art in the functions of the defect correction/Bayer noise suppression/color interpolation part 804 of FIG. 8 in the logic circuit 709 of FIG. 7, and different especially in the function of the Bayer noise suppression part.

### First Embodiment

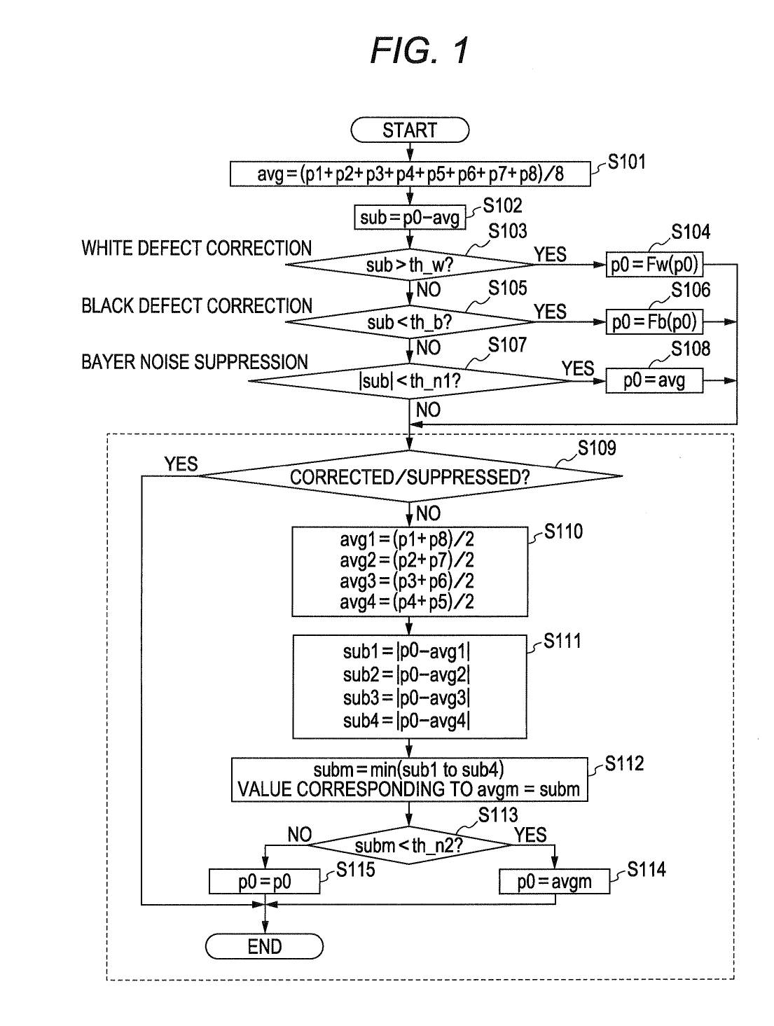

FIG. 1 is an operation flow chart depicting a defect correction function and the Bayer noise suppression function of the defect correction/Bayer noise suppression/color interpolation part 804 shown in FIG. 8.

This operation flow chart may be realized using firmware logic circuit, or may be realized as an operation where a computer constituted of a general central processing unit, a main storage device, an external storage device, a bus, and other known components executes a control program stored in the main storage device and the external storage device.

As depicted in FIG. 1, the average value avg of a brightness value of 8 pixels p1 to p8 of the same color (see, FIG. 10) surrounding a notice pixel p0 is calculated by the following formula (1) (step S101):

avg=(p1+p2+p3+p4+p5+p6+p7+p8)/8 (1)

Next, a difference between a notice pixel p0 and the average value avg is calculated by the following formula (2) (step S102):

sub=p0−avg (2)

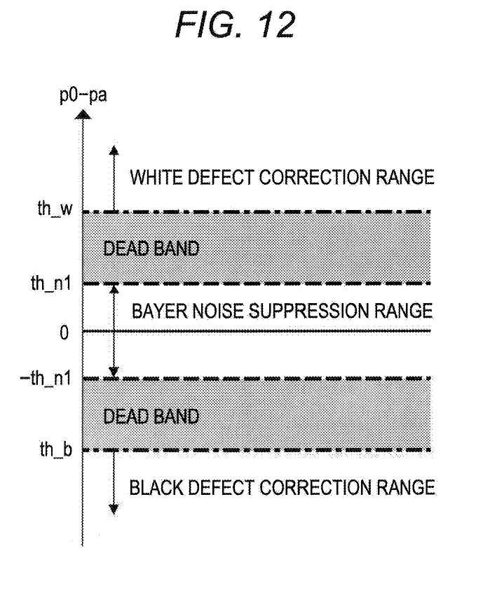

Next, the difference value sub is compared with the threshold value th_w (see, FIG. 12), set in the register 713 by the user (step S103).

When the difference value sub is larger than the threshold value th_w, the notice pixel p0 is judged to be a white defect pixel (see, FIG. 12), and the notice pixel p0 is replaced by a white defect correction function value Fw (p0) (step S104).

When the difference value sub is not more than the threshold value th_w, the difference value sub is then compared with the threshold value th_b (see, FIG. 12), set in the register 713 by a user (step S105).

When the difference value sub is smaller than the threshold value th_b, the notice pixel p0 is judged to be a black defect pixel (see, FIG. 12), the notice pixel p0 is replaced by a black defect correction function value Fb (p0) (step S106).

When the difference value sub is not less than the threshold value th_b, the absolute value |sub| of the difference value sub is then compared with the threshold value th_n1 (see, FIG. 12), set in the register 713 by a user (step S107).

When the absolute value |sub| is smaller than the threshold value th_n1, the notice pixel p0 is judged to be a Bayer noise pixel (see, FIG. 12), and the notice pixel p0 is replaced by the average value avg of the 8 surrounding pixels of the same color calculated in step S101 (step S108).

Next, a determination is made as to whether or not correction/suppression processing in steps S104, S106, or S108 has been executed. If the YES, the defect correction/Bayer noise suppression function processing applied to the present notice pixel p0 is terminated.

If the correction/suppression processing in step S104, S106, or S108 is not executed, and when the judgment in step S109 is NO, the following processing is executed.

First, vertical, horizontal, and diagonal average values avg1 to avg4 of the 8 surrounding pixels to the notice pixel p0 are calculated by the following formulae (3) (step S110):

avg1=(p1+p8)/2

avg2=(p2+p7)/2

avg3=(p3+p6)/2

avg4=(p4+p5)/2 (3)

Next, the absolute value of the difference between the notice pixel p0 and each of the average values avg1 to avg4 is calculated by the following formulae (4) (step S111):

sub1=|p0−avg1|

sub2=|p0−avg2|

sub3=|p0−avg3|

sub4=|p0−avg4| (4)

Subsequently, the value subm that is the minimum of the difference absolute values sub1 to sub 4 and the average value avgm corresponding to the value subm are detected (step S112). That is, the average value subm with the largest correlation with the notice pixel value p0 is calculated.

The value subm is then compared with a threshold value th_n2, set in the register 713 by a user (step S113).

When the value subm is smaller than the threshold value th_n2, the notice pixel p0 is judged to be the Bayer noise pixel, and the notice pixel p0 is replaced by the average value avgm calculated in step S112 (step S115).

Meanwhile, when the value subm is not less than the threshold value th_n2, the notice pixel p0 is judged to be a normal pixel and thus to be output as it is (step S116).

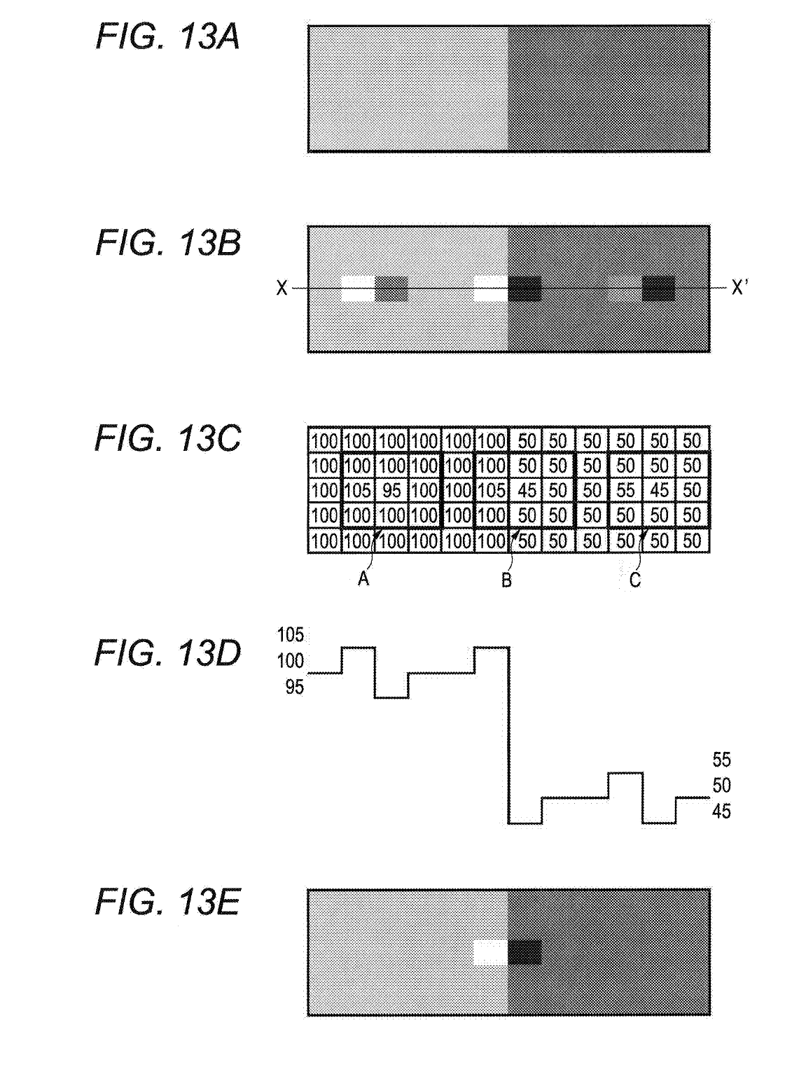

Specifically, in FIG. 13C, with regard to the notice pixel p0 in the range B where noise is not suppressed, if th_n2=7, the following formulae are calculated in step S110:

avg1=(p1+p8)/2=(50+100)/2=75

avg2=(p2+p7)/2=(50+50)/2=50

avg3=(p3+p6)/2=(100+50)/2=75

avg4=(p4+p5)/2=(50+105)/2=77.5

Further, the following formulae are calculated in step S111:

sub1=|p0−avg1|=|45−75|=30

sub2=|p0−avg2|=|45−50|=5

sub3=|p0−avg3|=|45−75|=30

sub4=|p0−avg4|=|45−77.5|=32.5

The value subm is judged as follows in steps 5112 and S113, and the Bayer noise suppression is executed in step S114:

subm=min (sub1 to sub4)=sub2<th_{—}n2

noise is suppressed

p0=avg2=50

As a result, an ideal image, such as the image as shown in FIG. 13A, may be output.

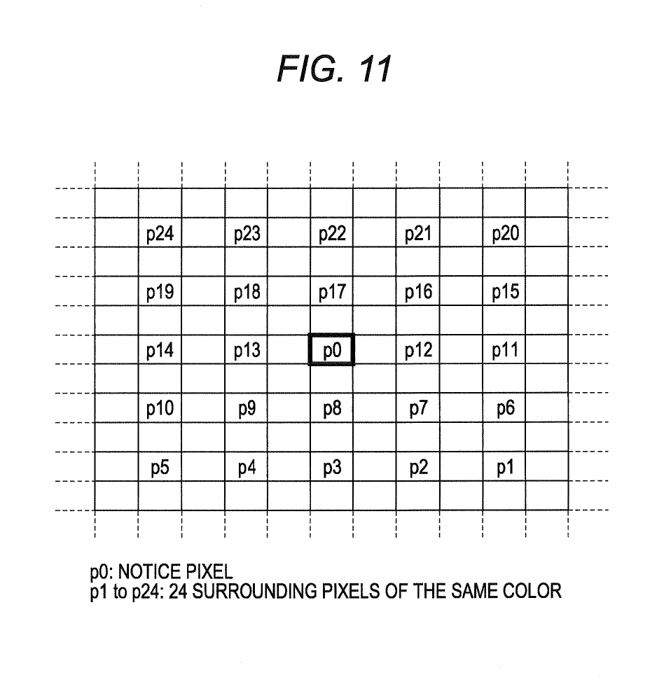

In the first embodiment described above, the processed objects are not limited to the notice pixel p0 and the 8 surrounding pixels of the same color, but the surrounding pixels may be expanded from 8 to 24 (see, FIG. 11). In this case, the average values avg1 to avg4 calculated in step S110 are replaced by the following formulae (5), and other processing is the same as those in the first embodiment:

avg1=(p1+p7+p18+p24)/4

avg2=(p3+p8+p17+p22)/4

avg3=(p5+p9+p16+p20)/4

avg4=(p11+p12+p13+p14)/4 (5)

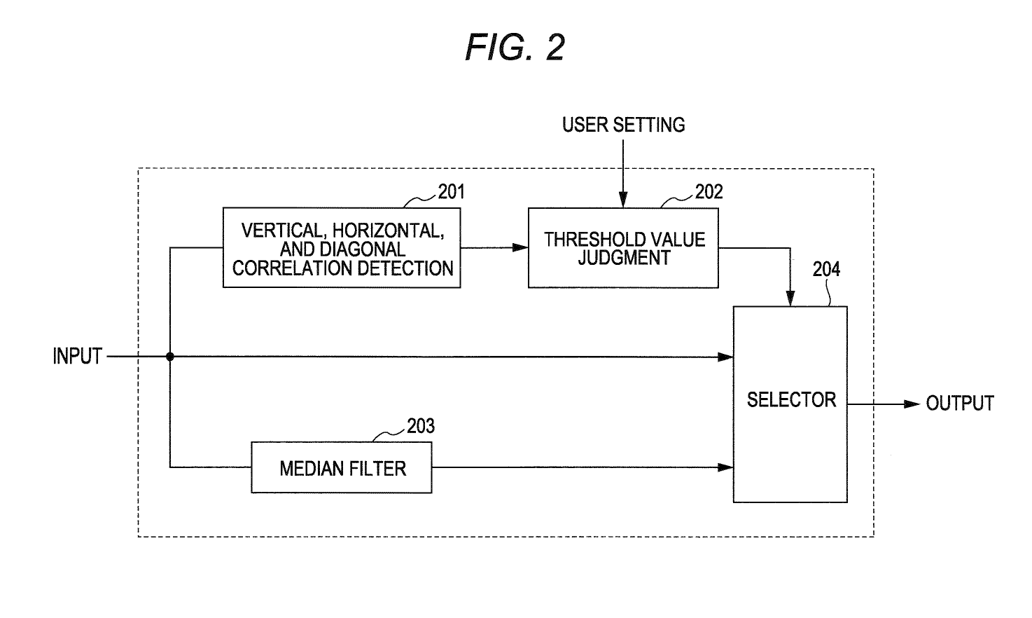

FIG. 2 is a functional block diagram showing a functional configuration of the Bayer noise suppression part of the first embodiment. A vertical, horizontal, and diagonal correlation detection part 201 realizes a function corresponding to the processing in steps S110 to S112 in FIG. 1. A threshold value judgment part 202 realizes a function corresponding to the processing in step S113 in FIG. 1. A median filter part 203 realizes a function corresponding to the processing in step S110 in FIG. 1. A selector 204 realizes a function corresponding to the processing in steps 5114 and S115 in FIG. 1.

### Second Embodiment

In the first embodiment described above, the difference absolute values sub1 to sub4 between the average values avg1 to avg4 generated only from two pixels and the notice pixel p0 are generated based on the formulae (3) and (4), and the difference absolute value subm with the largest correlation and the average value avgm corresponding to the difference absolute value subm are detected. In accordance with the second embodiment, in order to increase the stability of judgment, difference absolute values sub1 to sub8 between 8 average values avg1 to avg8 calculated from the 8 pixels of the same color surrounding notice pixel p0 are generated, and the difference absolute value subm with the largest correlation and the average value avgm corresponding to the difference absolute value subm are detected.

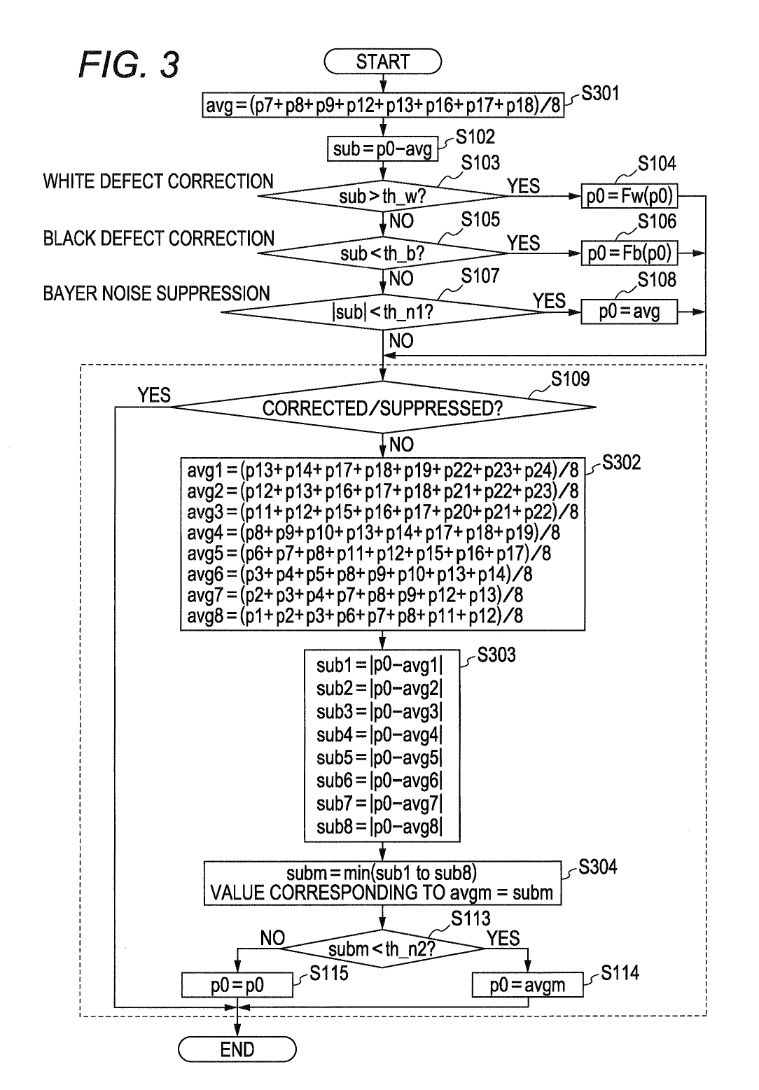

FIG. 3 is an operational flow chart, in accordance with the second embodiment, depicting a defect correction function and the Bayer noise suppression function which may be implemented in a defect correction/Bayer noise suppression/color interpolation part 804 shown in FIG. 8.

The operation flow chart of FIG. 3 may be realized using firmware logic circuit as in the case of FIG. 1 in the first embodiment, or may be realized as an operation where a computer constituted of a general central processing unit, a main storage device, an external storage device, a bus, and other known components executes a control program stored in the main storage device and the external storage device.

In FIG. 3, operations performed in and described above in relation to FIG. 1 are shown using the same reference numbers.

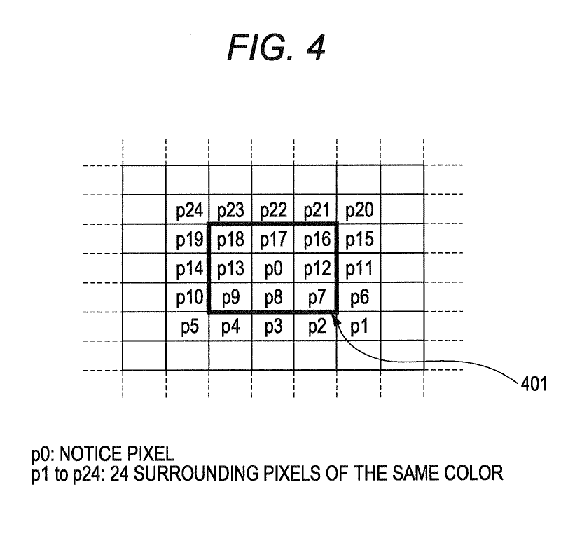

First, with respect to the notice pixel p0, the average value avg of brightness values of 8 surrounding pixels p7 to p9, p12, p13, and p16 to p18 represented by a reference numeral 401 of FIG. 4 is calculated by the following formula (6) (step S301):

avg=(p7+p8+p9+p12+p13+p16+p17+p18)/8 (6)

The following steps S102 to S109 are the same as those of FIG. 1.

When the correction/suppression processing in step S104, S106, or S108 is not executed, and when the judgment in step S109 is NO, the following processing is executed.

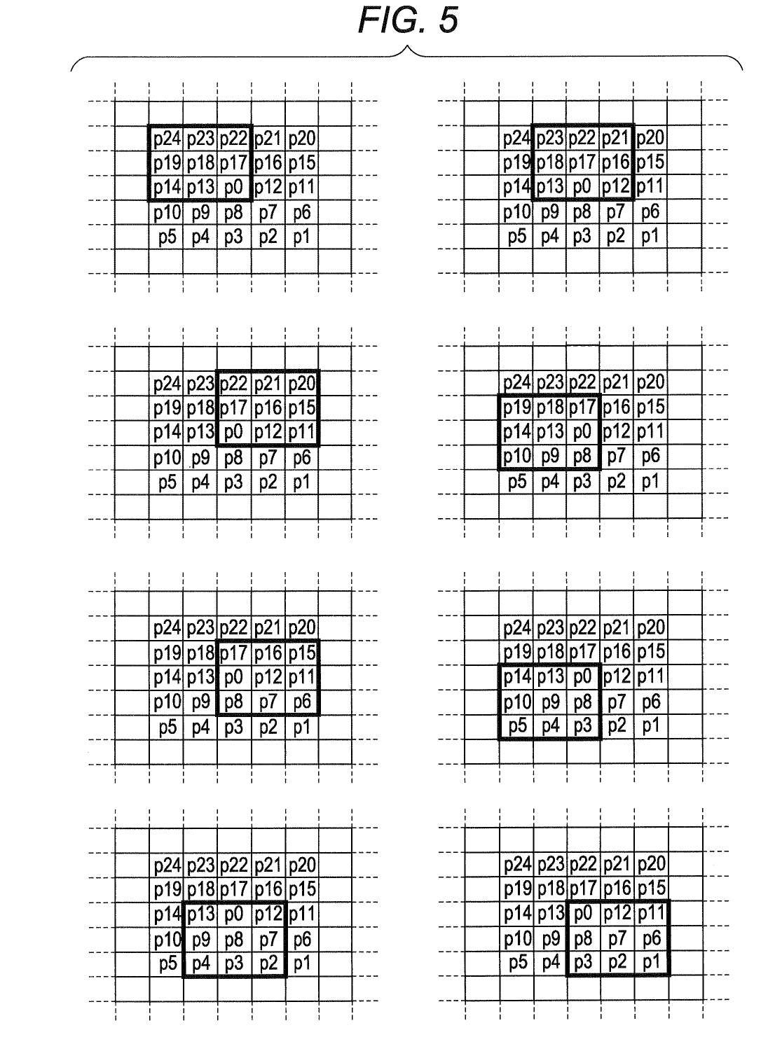

First, with respect to the notice pixel p0, as shown in FIG. 5, the 8 average values avg1 to avg8 to the notice pixel p0 are calculated from the 8 surrounding pixels of the same color by the following formulae (7) (step S302):

avg1=(p13+p14+p17+p18+p19+p22+p23+p24)/8

avg2=(p12+p13+p16+p17+p18+p21+p22+p23)/8

avg3=(p11+p12+p15+p16+p17+p20+p21+p22)/8

avg4=(p8+p9+p10+p13+p14+p17+p18+p19)/8

avg5=(p6+p7+p8+p11+p12+p15+p16+p17)/8

avg6=(p3+p4+p5+p8+p9+p10+p13+p14)/8

avg7=(p2+p3+p4+p7+p8+p9+p12+p13)/8

avg8=(p1+p2+p3+p6+p7+p8+p11+p12)/8 (7)

Next, the absolute value of the difference between the notice pixel p0 and each of the average value avg1 to avg8 is calculated by the following formulae (8) (step S303):

sub1=|p0−avg1|

sub2=|p0−avg2|

sub3=|p0−avg3|

sub4=|p0−avg4|

sub5=|p0−avg5|

sub6=|p0−avg6|

sub7=|p0−avg7|

sub8=|p0−avg8| (8)

The value subm which is the minimum of the difference absolute values sub1 to sub8 calculated by the formulae (8) and the average value avgm corresponding to the value subm are detected (step S304).

Using the largest correlation difference absolute value subm calculated as above, comparison judgment with the threshold value th_n2 and the Bayer noise suppression process are executed in steps S113 to S115 as in the case of FIG. 1, whereby the brightness boundary can be stably detected, and thus more stable Bayer noise suppression can be realized.

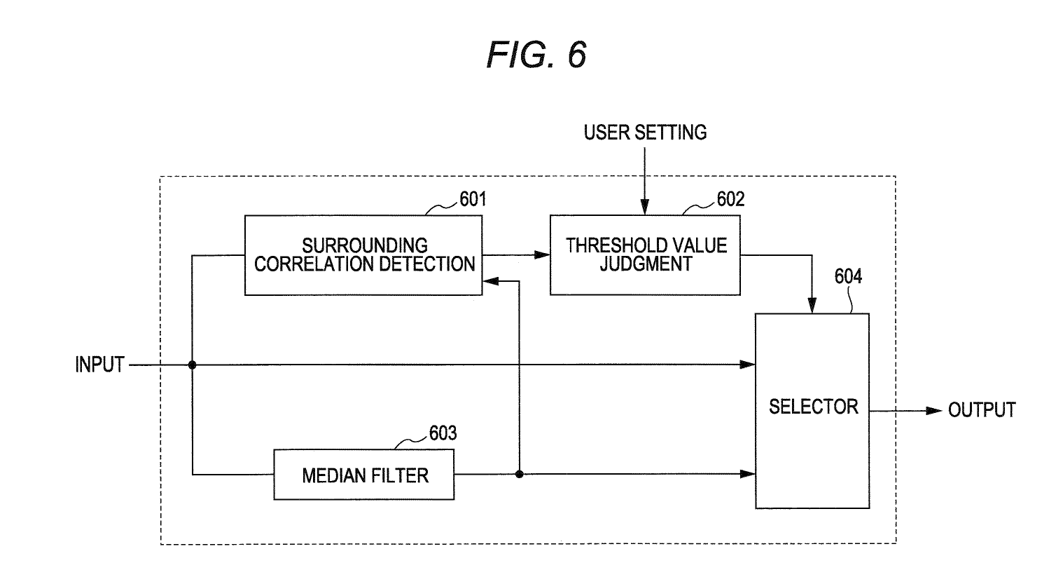

FIG. 6 is a functional block view showing a functional configuration of a Bayer noise suppression part in accordance with the second embodiment. A surrounding correlation detection part 601 realizes a function corresponding to the processing in steps S302 to S304 in FIG. 3. A threshold value judgment part 602 realizes a function corresponding to the processing in step S113 in FIG. 3. A median filter part 603 realizes a function corresponding to the processing in step S302 in FIG. 3. A selector 604 realizes a function corresponding to the processing in steps S114 and S115 in FIG. 3.

The constitution of the first embodiment realizes the effective detection and suppression of not only noise generated in a portion where the brightness of an image is uniform, but also noise generated in a boundary portion of an image with a large difference in brightness, whereby the correction effect of a pixel signal can be enhanced. The constitution of the second embodiment realizes more stable detection of the boundary portion and the noise suppression based on the detection.

In each embodiment described above, although this invention is described in relation to a logic circuit of an image sensor system, a digital camera, a cell phone, a PC, and so on in which this image sensor system may be incorporated are included in the scope of the claims of this invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A noise removal circuit in an image signal, comprising:
a boundary determination unit configured to determine a position of a light-dark boundary as a function of a pixel value of a plurality of surrounding pixels; and
a selection filter configured to perform filtering in a range of the plurality of surrounding pixels, the filtering range being in a range which does not cross a boundary determined by the boundary determination unit.

2. A method for suppressing noise in an image signal, comprising:
calculating a difference absolute value between a notice pixel and an average value of a plurality of surrounding pixels of the same color around the notice pixel;
replacing a value of the notice pixel by the average value of the surrounding pixels when the difference absolute value is less than a threshold value;
calculating a difference absolute value between the notice pixel and each of vertical, horizontal, and diagonal average values of surrounding pixels of the same color around the notice pixel when the difference absolute value is not less than the threshold value; and
replacing the value of the notice pixel by an average value corresponding to the minimum one of the difference absolute values.

3. The method for suppressing noise according to claim 2, wherein the number of the surrounding pixels is 8.

4. The method for suppressing noise according to claim 2, wherein the number of the surrounding pixels is 24.

5. A circuit for suppressing noise in an image signal, comprising:
a first calculator configured to calculate a difference absolute value between a notice pixel and an average value of a plurality of surrounding pixels of the same color around the notice pixel;
a first replace unit configured to replace a value of the notice pixel by the average value of the surrounding pixels of the same color when the difference absolute value is less than a threshold value;
a second replace unit configured to replace a value of the notice pixel by the average of the surrounding pixels when the difference absolute value is less than a threshold value;
a second calculator configured for calculating a difference absolute value between the notice pixel and each of vertical, horizontal, and diagonal average values of surrounding pixels of the same color around the notice pixel when the difference absolute value is not less than the threshold value; and
a third replace unit configured to replace the value of the notice pixel by an average value corresponding to the minimum one of the difference absolute values.

6. The circuit for suppressing noise according to claim 5, wherein the number of the surrounding pixels is 8.

7. The circuit for suppressing noise according to claims 5, wherein the number of the surrounding pixels is 24.

8. A method for suppressing noise in an image signal, comprising:
calculating a difference absolute value between a notice pixel and 8 surrounding pixels of the same color around the notice pixel;
replacing a value of the notice pixel by the average value of the 8 surrounding pixels of the same color when the difference absolute value is less than a threshold value;
calculating a difference absolute value between each average value in 8 ranges of 3 by 3 pixels, each range including the notice pixel, and the notice pixel when the difference absolute value is not less than the threshold value; and
replacing the value of the notice pixel by the average value corresponding to the minimum one of the difference absolute values.

9. A circuit for suppressing noise in an image signal, comprising:
a first calculator configured to calculate a difference absolute value between a notice pixel and an average value of 8 surrounding pixels of the same color around the notice pixel;
a first replace unit configured to replace a value of the notice pixel by the average value of the 8 surrounding pixels of the same color when the difference absolute value is less than a threshold value;
a second calculator configured to calculate a difference absolute value between each average value in 8 ranges of 3 by 3 pixels, each range including the notice pixel, and the notice pixel when the difference absolute value is not less than the threshold value; and
a second replace unit configured to replace the value of the notice pixel by the average value corresponding to the minimum one of the difference absolute values.
